(19) United States
(12) Patent Application Publication
(10) Pub. No.: US 2022/0316366 A1
(43) Pub. Date: Oct. 6, 2022

(54) VALVE TIMING ADJUSTMENT DEVICE

(71) Applicant: Mitsubishi Electric Corporation, Tokyo (JP)

(72) Inventor: Takuhiro MATSUMOTO, Tokyo (JP)

(73) Assignee: Mitsubishi Electric Corporation, Tokyo (JP)

(21) Appl. No.: 17/634,171

(22) PCT Filed: Oct. 21, 2019
(86) PCT No.: PCT/JP2019/041249

§ 371 Date: Feb. 9, 2022

(51) Int. Cl. F01L 1/344; F16B 33/00

(52) U.S. Cl. CPC F01L 1/3442; F16B 33/002

(57) ABSTRACT

A VVT includes: a cylindrical case to rotate synchronously with a crankshaft; a rotor housed in the case and to rotate synchronously with a camshaft; a first cover that has a first through hole and closes one opening of the case; a second cover that has a second through hole and closes another opening of the case; a first fastening member that fixes, in a state of passing through the first through hole, the first cover and the case; and a second fastening member that fixes, in a state of passing through the second through hole, the second cover and the case.

### TECHNICAL FIELD

The present invention relates to a valve timing adjustment device.

### BACKGROUND ART

A variable valve timing adjustment device (hereinafter referred to as “VVT”) is a device that adjusts opening and closing timing of an intake valve or an exhaust valve of an engine of a vehicle, and includes a cylindrical case that rotates synchronously with a crankshaft, a rotor that rotates synchronously with a camshaft, a cover that closes one opening of the case, and a plate that closes another opening of the case. In a conventional VVT, a cover and a plate are fixed to a case by bolts while a rotor is housed in the case (see, for example, Patent Literature 1).

### CITATION LIST

### Patent Literatures

Patent Literature 1: JP 2017-101608 A

### SUMMARY OF INVENTION

### Technical Problem

In the conventional VVT as described in Patent Literature 1, the bolt is inserted, from a plate side, into a through hole of the plate and a through hole of the case, and is fastened to a female screw formed in the cover. In this structure, since the female screw formed in the cover has a shape protruding to a side opposite to the case, the thickness of the VVT increases by the thickness of the female screw. On the other hand, in a case where the female screw has a shape protruding to a case side, the VVT can be thinned by housing the female screw in the case. However, since axial force generated at the time of fastening the bolt acts on the cover with the female screw as a starting point, the entire cover is curved, and thus a gap is generated between the cover and the case, so that oil leakage through this gap occurs.

The present invention has been made to solve the above problems, and an object of the present invention is to avoid a fastening structure by a female screw having a shape protruding to a side opposite to a case and to suppress oil leakage.

### Solution to Problem

A valve timing adjustment device according to the present invention includes: a cylindrical case to rotate synchronously with a crankshaft; a rotor housed in the case and to rotate synchronously with a camshaft; a first cover that has a first through hole and closes one opening of the case; a second cover that has a second through hole and closes another opening of the case; a first fastening member that fixes, in a state of passing through the first through hole, the first cover and the case; and a second fastening member that fixes, in a state of passing through the second through hole, the second cover and the case.

### Advantageous Effects of Invention

According to the present invention, since a female screw having a shape protruding to a side opposite to the case is not provided in the first cover and the second cover, the VVT can be thinned. In addition, since axial force generated at the time of fastening the bolt does not act on the first cover and the second cover with the female screw as a starting point, the first cover and the second cover are hardly deformed, and thus oil leakage can be suppressed.

### BRIEF DESCRIPTION OF DRAWINGS

FIG. 1 illustrates a configuration example of a VVT according to a first embodiment, in which FIG. 1A is a front view, FIG. 1B is a rear view, FIG. 1C is a cross-sectional view taken along line A-A, and FIG. 1D is an enlarged view of a fastening structure.

FIG. 2 illustrates an example of a conventional VVT, in which FIG. 2A is a front view, FIG. 2B is a cross-sectional view taken along line B-B, and FIG. 2C is an enlarged view of a fastening structure.

FIG. 3 illustrates another example of a conventional VVT, in which FIG. 3A is a front view, FIG. 3B is a cross-sectional view taken along line C-C, and FIG. 3C is an enlarged view of a fastening structure.

FIG. 4 illustrates a configuration example of a VVT according to a second embodiment, in which FIG. 4A is a front view, FIG. 4B is a cross-sectional view taken along line D-D, and FIG. 4C is an enlarged view of a fastening structure.

FIG. 5 is a front view illustrating a configuration example of a VVT according to a third embodiment, and shows an example in which a first rotation stopper is provided on a flange.

FIG. 6 is a front view illustrating another configuration example of the VVT according to the third embodiment, and shows an example in which a second rotation stopper is provided on a cylinder.

FIG. 7 is an external perspective view of a nut in which the second rotation stopper is provided on the cylinder.

FIG. 8 is an enlarged view of a fastening structure in a VVT according to a fourth embodiment.

### DESCRIPTION OF EMBODIMENTS

Hereinafter, in order to explain the present invention in more detail, embodiments for carrying out the present invention will be described with reference to the accompanying drawings.

### First Embodiment

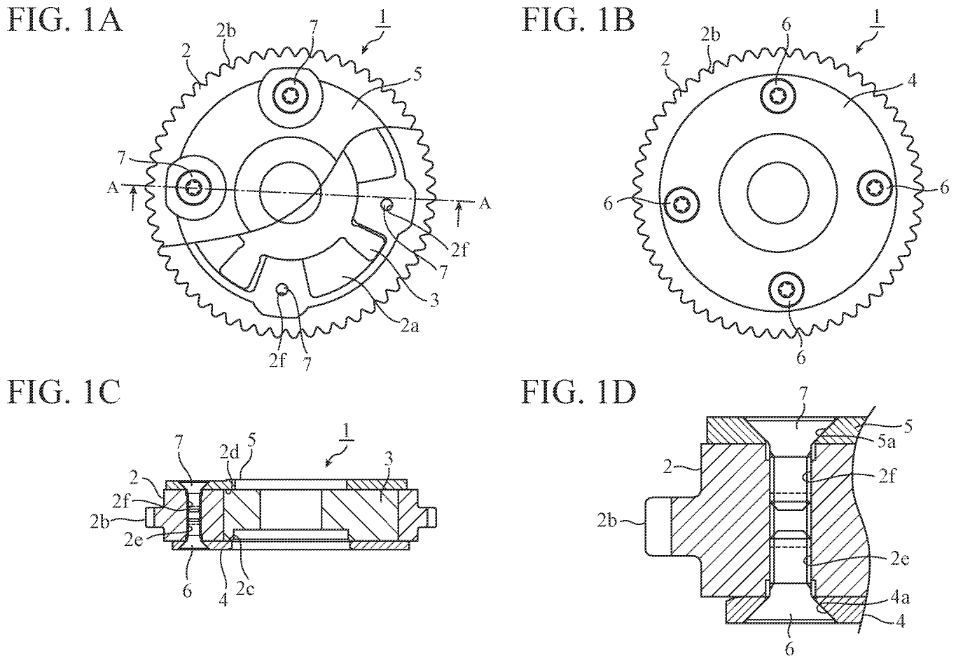

FIG. 1 is a diagram illustrating a configuration example of a VVT 1 according to a first embodiment, in which FIG. 1A is a front view, FIG. 1B is a rear view, FIG. 1C is a cross-sectional view taken along A-A, and FIG. 1D is an enlarged view of a fastening structure of the VVT 1. Note that, in FIG. 1A, a part of a second cover 5 is omitted, and thus an internal structure of a case 2 is exposed.

A plurality of hydraulic chambers 2a is formed inside the cylindrical case 2. Each of the plurality of hydraulic chambers 2a is partitioned into an advance hydraulic chamber and a retard hydraulic chamber by a rotor 3 housed in the case 2. In a state where the rotor 3 is housed inside the case 2, a first cover 4 is fixed to a first opening 2c side of the case 2, and the second cover 5 is fixed to a second opening 2d side of the case 2. By closing the first opening 2c and the second opening 2d of the case 2, the hydraulic chamber 2a is sealed. A sprocket 2b is formed on the outer peripheral surface of the case 2, and by a timing belt (not illustrated) attached to the sprocket 2b, driving force of a crankshaft of an engine is transmitted to the case 2, and thus the case 2 rotates synchronously with the crankshaft. On the other hand, the rotor 3 is fixed to a camshaft (not illustrated) and rotates synchronously with the camshaft. As hydraulic pressure in the hydraulic chamber 2a changes, a rotational phase of the rotor 3 with respect to the case 2 changes.

As illustrated in FIG. 1D, the case 2, the first cover 4, and the second cover 5 are integrated by bolts 6 and 7. The bolt 6 is a “first fastening member”, and the bolt 7 is a “second fastening member”.

The first cover 4 has a first through hole 4a through which the bolt 6 passes. The case 2 has a first screw hole 2e which is provided at a position facing the first through hole 4a and to which the bolt 6 is fastened. The bolt 6 passes through the first through hole 4a and is fastened to the first screw hole 2e of the case 2. By fastening the bolt 6 to the first screw hole 2e, the first cover 4 and the case 2 are fixed. In a state where the bolt 6 is fastened, the head of the bolt 6 is housed in the first through hole 4a and thus does not protrude to the outside of the first cover 4.

The second cover 5 has a second through hole 5a through which the bolt 7 passes. The case 2 has a second screw hole 2f which is provided at a position facing the second through hole 5a and to which the bolt 7 is fastened. The bolt 7 passes through the second through hole 5a and is fastened to the second screw hole 2f of the case 2. By fastening the bolt 7 to the second screw hole 2f, the second cover 5 and the case 2 are fixed. In a state where the bolt 7 is fastened, the head of the bolt 7 is housed in the second through hole 5a and thus does not protrude to the outside of the second cover 5.

Note that, in the illustrated example, one end of one screw hole penetrating the case 2 constitutes the first screw hole 2e, and another end thereof constitutes the second screw hole 2f. However, the first screw hole 2e and the second screw hole 2f may be individually provided. Further, the number of bolts 6 and 7 may be any number. Further, in the illustrated example, the bolts 6 and 7 are countersunk screws, but shapes of the bolts 6 and 7 may be any shape.

Next, effects achieved by the configuration of the first embodiment will be described while referring to two conventional examples.

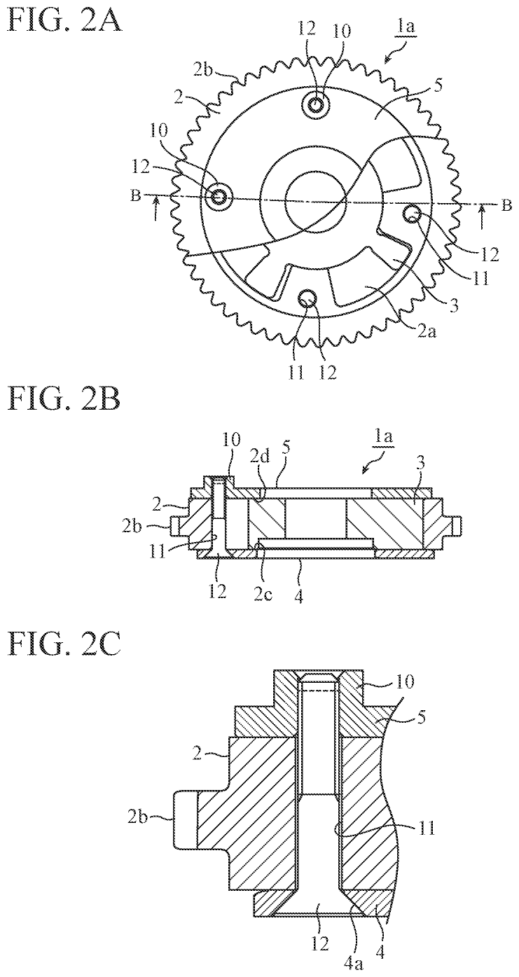

FIG. 2 is a diagram illustrating an example of a conventional VVT 1a, in which FIG. 2A is a front view, FIG. 2B is a cross-sectional view taken along line B-B, and FIG. 2C is an enlarged view of a fastening structure. In FIG. 2, the same or corresponding parts as those in FIG. 1 are denoted by the same reference numerals, and description thereof is omitted. In FIG. 2A, a part of the second cover 5 is omitted, and thus the internal structure of the case 2 is exposed.

In the conventional VVT 1a, the second cover 5 is provided with a female screw 10. This female screw 10 has a shape protruding to a side opposite to the case 2. A bolt 12 passes through the first through hole 4a provided in the first cover 4, passes through a through hole 11 provided in the case 2, and is fastened to the female screw 10. By fastening the bolt 12 to the female screw 10, the first cover 4, the second cover 5, and the case 2 are fixed. In a case of this conventional example, since the female screw 10 has the shape protruding to the side opposite to the case 2, the thickness of the VVT 1a increases by the thickness of the female screw 10. An increase in the thickness of the VVT 1a hinders space saving of an engine.

However, in the case of the conventional example in FIG. 2, since a surface of the second cover 5 on a case 2 side is supported by an entire surface of the case 2, even if axial force generated at the time of fastening the bolt 12 acts on the second cover 5, the second cover 5 is hardly curved. Therefore, a gap is less likely to be generated between the case 2 and the second cover 5, and thus oil leakage from the hydraulic chamber 2a to the outside of the VVT 1a can be suppressed.

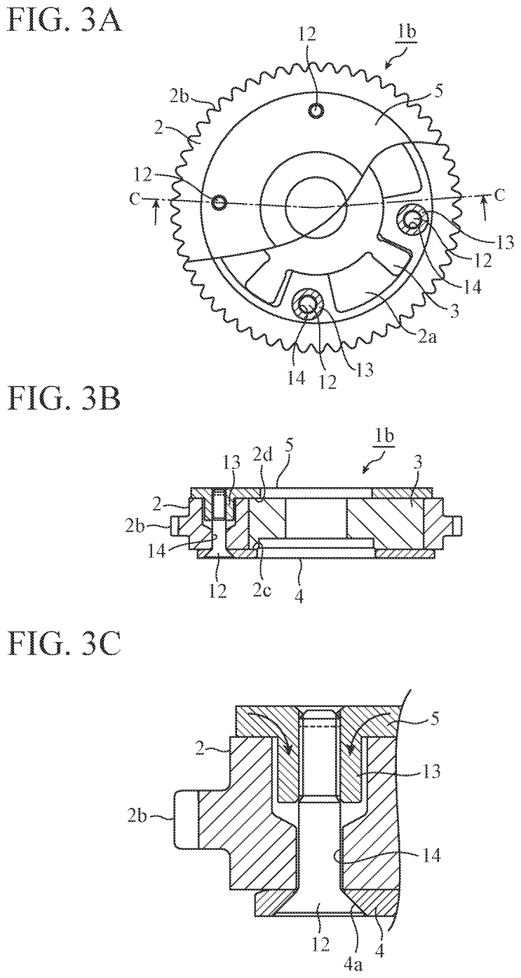

FIG. 3 is a diagram illustrating another example of a conventional VVT 1b, in which FIG. 3A is a front view, FIG. 3B is a cross-sectional view taken along line C-C, and FIG. 3C is an enlarged view of a fastening structure. In FIG. 3, the same or corresponding parts as those in FIG. 1 are denoted by the same reference numerals, and description thereof is omitted. In FIG. 3A, a part of the second cover 5 is omitted, and thus the internal structure of the case 2 is exposed.

In the conventional VVT 1b, similarly to the VVT 1a, a female screw 13 is provided in the second cover 5. This female screw 13 has a shape protruding to the case 2 side and is housed in a through hole 14 of the case 2. The bolt 12 passes through the first through hole 4a provided in the first cover 4, passes through the through hole 14 provided in the case 2, and is fastened to the female screw 13. By fastening the bolt 12 to the female screw 13, the first cover 4, the second cover 5, and the case 2 are fixed. In a case of this conventional example, by avoiding the fastening structure by the female screw 10 having the shape protruding to the side opposite to the case 2, it is possible to reduce the thickness of the VVT 1b as compared with the VVT 1a.

However, in the case of the conventional example in FIG. 3, axial force generated at the time of fastening the bolt 12 acts on the second cover 5 with the female screw 13 as a starting point, whereby a rotational moment is generated in the second cover 5, so that the second cover 5 is curved in a direction indicated by arrows in FIG. 3C. Therefore, a gap is generated between the case 2 and the second cover 5, and oil leaks from the hydraulic chamber 2a to the outside of the VVT 1b through this gap. In order to drive the VVT 1b, it is necessary to increase hydraulic pressure of the hydraulic chamber 2a reduced by the oil leakage, and as a result, fuel consumption of the engine deteriorates.

In the VVT 1 according to the first embodiment, the first screw hole 2e and the second screw hole 2f for fastening the respective bolts 6 and 7 are provided in the case 2. That is, since the female screw 10 having the shape protruding to the side opposite to the case 2 is not provided in the first cover 4 and the second cover 5, the VVT 1 can be made thinner than the VVT 1a. Therefore, a space of the engine can be saved. In addition, in the VVT 1 according to the first embodiment, since the female screw 13 is not provided in the first cover 4 and the second cover 5, axial force generated at the time of fastening the bolts 6 and 7 does not act on the first cover 4 and the second cover 5 with the female screw 13 as a starting point. Therefore, the first cover 4 and the second cover 5 are less likely to be deformed, and thus oil leakage from the hydraulic chamber 2a to the outside of the VVT 1 can be suppressed. Therefore, fuel consumption of the engine can be improved.

### Second Embodiment

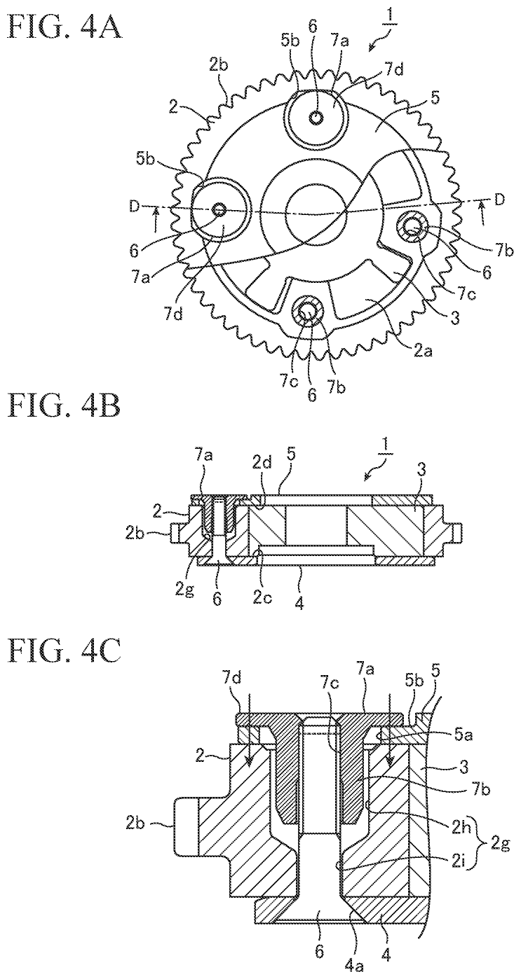

FIG. 4 is a diagram illustrating a configuration example of a VVT 1 according to a second embodiment, in which FIG. 4A is a front view, FIG. 4B is a cross-sectional view taken along line D-D, and FIG. 4C is an enlarged view of a fastening structure. In FIG. 4, the same or corresponding parts as those in FIG. 1 are denoted by the same reference numerals, and description thereof is omitted. In FIG. 4A, a part of the second cover 5 is omitted, and thus the internal structure of the case 2 is exposed.

In the first embodiment, the first fastening member and the second fastening member are the respective bolts 6 and 7, but in the second embodiment, the first fastening member is the bolt 6 and the second fastening member is a nut 7a. The nut 7a includes a cylinder 7b and a flange 7d. The cylinder 7b has the inner peripheral surface provided with a female screw 7c, and passes through the second through hole 5a provided in the second cover 5. The flange 7d is provided on an end side of the cylinder 7b and is caught by a rim of the second through hole 5a.

The case 2 of the second embodiment has a third through hole 2g provided at a position facing the first through hole 4a of the first cover 4 and the second through hole 5a of the second cover 5. In the third through hole 2g, a first cover 4 side is a bolt passing portion 2i through which the bolt 6 passes, and a second cover 5 side is a cylinder housing 2h that houses the cylinder 7b of the nut 7a. The bolt 6 passes through the first through hole 4a provided in the first cover 4, passes through the bolt passing portion 2i of the case 2, and is fastened to the female screw 7c of the cylinder 7b housed in the cylinder housing 2h.

As described above, in the second embodiment, since the cylinder 7b for fastening the bolt 6 is housed in the case 2, it is possible to reduce the thickness of the VVT 1 as compared with the conventional VVT 1a as illustrated in FIG. 2. In addition, since axial force generated at the time of fastening the bolt 6 is vertically transmitted from the nut 7a to the second cover 5 as indicated by arrows in FIG. 4C, the rotational moment in the second cover 5 as in the conventional VVT 1b illustrated in FIG. 3C is not generated. Therefore, the second cover 5 is not curved, and thus oil leakage from the hydraulic chamber 2a to the outside of the VVT 1 can be suppressed.

Note that, in the example of FIG. 4, a recess 5b is provided at the rim of the second through hole 5a in the second cover 5 so that the flange 7d does not protrude to the outside of the second cover 5. By housing the flange 7d in the recess 5b, it is possible to further reduce the thickness of the VVT 1.

Further, in the example of FIG. 4, the cylinder 7b of the nut 7a is housed in the case 2, but the cylinder 7b may protrude to the side opposite to the case 2. Also in this structure, since the second cover 5 is not curved due to axial force generated at the time of fastening the bolt 6, oil leakage from the hydraulic chamber 2a to the outside of the VVT 1 can be suppressed.

Further, in the example of FIG. 4, the bolt 6 is installed on the first cover 4 side and the nut 7a is installed on the second cover 5 side. Alternatively, the nut 7a may be installed on the first cover 4 side and the bolt 6 may be installed on the second cover 5 side.

### Third Embodiment

In the VVT 1 according to the second embodiment, since the cylinder 7b of the nut 7a is housed in the case 2, it is difficult for a worker to stop rotation of the nut 7a by using a tool or the like when fastening the bolt 6 to the nut 7a. In order for the nut 7a not to rotate at the time of fastening the bolt 6, frictional force between the flange 7d of the nut 7a and the recess 5b of the second cover 5 needs to be larger than fastening torque of the bolt 6. For this purpose, the flange 7d or the recess 5b needs to be subjected to surface treatment (for example, shot blasting) for increasing a friction coefficient. This surface treatment leads to an increase in cost of the VVT 1. Therefore, in a third embodiment, an inexpensive rotation stopping mechanism is added to the VVT 1 instead of the surface treatment described above.

Specifically, in the third embodiment, at least one of the flange 7d and the cylinder 7b of the nut 7a illustrated in the second embodiment is provided with a rotation stopper having a shape that prevents rotation of the nut 7a when the bolt 6 is fastened to the nut 7a.

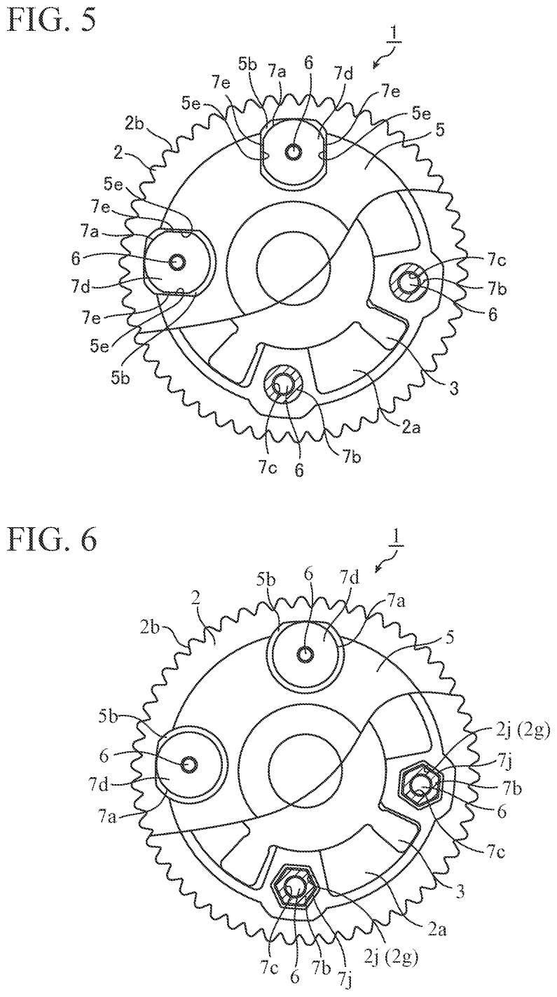

FIG. 5 is a front view illustrating a configuration example of the VVT 1 according to the third embodiment, and shows an example in which a first rotation stopper 7e is provided on the flange 7d. In FIG. 5, the same or corresponding parts as those in FIG. 4 are denoted by the same reference numerals, and description thereof is omitted. In FIG. 5, a part of the second cover 5 is omitted, and thus the internal structure of the case 2 is exposed.

The flange 7d has the first rotation stopper 7e having a shape that prevents rotation of the nut 7a. In the example of FIG. 5, the first rotation stopper 7e has two opposing planes provided on the outer periphery of the flange 7d. Note that the shape of the first rotation stopper 7e is not limited to the shape illustrated in FIG. 5, and may be one or more planes, a gear shape, or the like provided on the outer periphery of the flange 7d.

On the other hand, the second cover 5 has a first fitting portion 5e fitted to the first rotation stopper 7e of the flange 7d. In the example of FIG. 5, the first fitting portion 5e has two opposing planes provided on the inner periphery of the recess 5b. Note that the shape of the first fitting portion 5e may be any shape as long as the first fitting portion 5e can be fitted to the first rotation stopper 7e to stop the rotation of the nut 7a, and can be changed to any shape matching the shape of the first rotation stopper 7e.

As described above, in the example of FIG. 5, the flange 7d has the first rotation stopper 7e having the shape that prevents the rotation of the nut 7a. The second cover 5 has the first fitting portion 5e fitted to the first rotation stopper 7e of the flange 7d. Since the rotation of the nut 7a at the time of fastening the bolt 6 can be prevented by the first rotation stopper 7e and the first fitting portion 5e, productivity of the VVT 1 is improved. In addition, since addition of the first rotation stopper 7e and the first fitting portion 5e is inexpensive as compared with the above-described surface treatment, it is possible to suppress an increase in cost of the VVT 1.

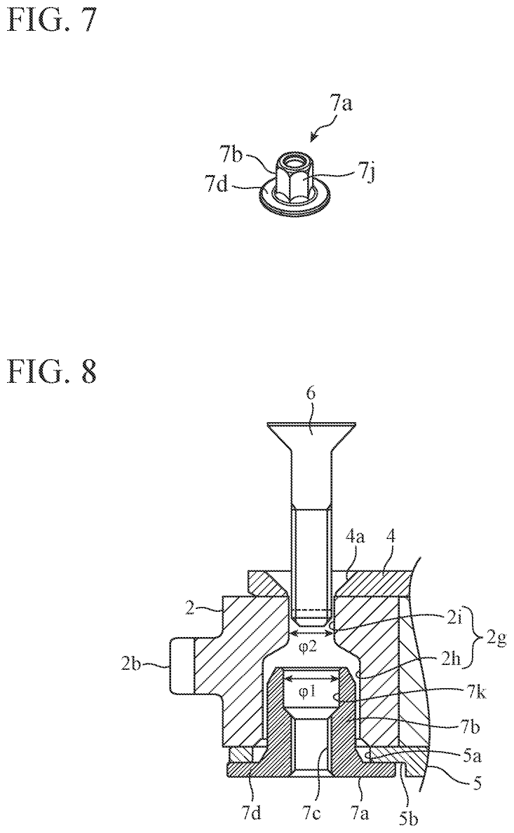

FIG. 6 is a front view illustrating another configuration example of the VVT 1 according to the third embodiment, and shows an example in which a second rotation stopper 7j is provided on the cylinder 7b. FIG. 7 is an external perspective view of the nut 7a in which the second rotation stopper 7j is provided on the cylinder 7b. In FIGS. 6 and 7, the same or corresponding parts as those in FIG. 4 are denoted by the same reference numerals, and description thereof is omitted. In FIG. 6, a part of the second cover 5 is omitted, and this the internal structure of the case 2 is exposed.

The cylinder 7b has the second rotation stopper 7j provided on the outer peripheral surface of the cylinder 7b and having a shape that prevents rotation of the nut 7a. In the examples of FIGS. 6 and 7, the second rotation stopper 7j has six planes provided on the outer peripheral surface of the cylinder 7b. Note that the shape of the second rotation stopper 7j is not limited to the shape illustrated in FIGS. 6 and 7, and may be one or more planes, a gear shape, or the like provided on the outer periphery of the cylinder 7b.

On the other hand, the case 2 has a second fitting portion 2j provided on the inner peripheral surface of the third through hole 2g and fitted to the second rotation stopper 7j of the cylinder 7b. In the example of FIG. 6, the second fitting portion 2j has six planes provided on the inner peripheral surface of the third through hole 2g. Note that the shape of the second fitting portion 2j may be any shape as long as the second fitting portion 2j can be fitted to the second rotation stopper 7j to stop the rotation of the nut 7a, and can be changed to any shape matching the shape of the second rotation stopper 7j.

As described above, in the example of FIGS. 6 and 7, the cylinder 7b has the second rotation stopper 7j provided on the outer peripheral surface of the cylinder 7b and having the shape that prevents the rotation of the nut 7a. The case 2 has the second fitting portion 2j provided on the inner peripheral surface of the third through hole 2g and fitted to the second rotation stopper 7j of the cylinder 7b. Since the rotation of the nut 7a at the time of fastening the bolt 6 can be prevented by the second rotation stopper 7j and the second fitting portion 2j, productivity of the VVT 1 is improved. In addition, since addition of the second rotation stopper 7j and the second fitting portion 2j is inexpensive as compared with the above-described surface treatment, it is possible to suppress an increase in cost of the VVT 1.

Note that both a set of the first rotation stopper 7e and the first fitting portion 5e and a set of the second rotation stopper 7j and the second fitting portion 2j may be added to the VVT 1.

In addition, in a case where an increase in the cost of the VVT 1 is allowed, instead of the set of the first rotation stopper 7e and the first fitting portion 5e and the set of the second rotation stopper 7j and the second fitting portion 2j, the surface treatment described above may be performed.

### Fourth Embodiment

FIG. 8 is an enlarged view of a fastening structure in the VVT 1 according to a fourth embodiment. In FIG. 8, the same or corresponding parts as those in FIG. 4 are denoted by the same reference numerals, and description thereof is omitted.

As illustrated in FIG. 8, the cylinder 7b of the nut 7a has a large inner diameter portion 7k through which the bolt 6 passes on a side opposite to the end side of the cylinder 7b, the flange 7d being provided on the ends side. An inner diameter φ1 of this large inner diameter portion 7k is larger than an inner diameter φ2 of the bolt passing portion 2i of the third through hole 2g provided in the case 2. Since φ1>φ2, when a worker inserts the bolt 6 from the first through hole 4a of the first cover 4 and assembles it to the cylinder 7b, the bolt 6 enters the large inner diameter portion 7k without riding on a rim of the cylinder 7b. Therefore, assemblability of the bolt 6 is improved.

Note that the set of the first rotation stopper 7e and the first fitting portion 5e, or the set of the second rotation stopper 7j and the second fitting portion 2j illustrated in the third embodiment may be added to the fastening structure illustrated in FIG. 8.

The present invention can freely combine embodiments, modify any components in the embodiments, or omit any components in the embodiments within the scope of the invention.

### INDUSTRIAL APPLICABILITY

Since the VVT according to the present invention achieves reduction in thickness and suppression of oil leakage, it is suitable for use in an engine that requires space saving and improvement in fuel efficiency.

### REFERENCE SIGNS LIST

1, 1a, 1b: VVT, 2: case, 2a: hydraulic chamber, 2b: sprocket, 2c: first opening, 2d: second opening, 2e: first screw hole, 2f: second screw hole, 2g: third through hole, 2h: cylinder housing, 2i: bolt passing portion, 2j: second fitting portion, 3: rotor, 4: first cover, 4a: first through hole, 5: second cover, 5a: second through hole, 5b: recess, 5e: first fitting portion, 6: bolt (first fastening member), 7: bolt (second fastening member), 7a: nut (second fastening member), 7b: cylinder, 7c: female screw, 7d: flange, 7e: first rotation stopper, 7j: second rotation stopper, 7k: large inner diameter portion, 10, 13: female screw, 11, 14: through hole, 12: bolt, φ1, φ2: inner diameter

1. A valve timing adjustment device, comprising:
a cylindrical case to rotate synchronously with a crankshaft;
a rotor housed in the case and to rotate synchronously with a camshaft;
a first cover that has a first through hole and closes one opening of the case;
a second cover that has a second through hole and closes another opening of the case;
a first fastening member that fixes, in a state of passing through the first through hole, the first cover and the case; and
a second fastening member that fixes, in a state of passing through the second through hole, the second cover and the case.

2. The valve timing adjustment device according to claim 1, wherein provided at a position facing the first through hole the first fastening member and the second fastening member are respective bolts, and
the case includes: a first screw hole which is provided at a position facing the first through hole and to which the first fastening member is fastened; and a second screw hole which is provided at a position facing the second through hole and to which the second fastening member is fastened.

3. The valve timing adjustment device according to claim 1, wherein the second fastening member is a nut including: a cylinder provided with a female screw on an inner peripheral surface of the cylinder and passing through the second through hole; and a flange provided on an end side of the cylinder and caught by a rim of the second through hole,
the first fastening member is a bolt fastened to the nut, and
the case includes a third through hole which is provided at a position facing the first through hole and the second through hole, which houses the cylinder of the nut, and through which the bolt passes.

4. The valve timing adjustment device according to claim 3, wherein the flange includes a first rotation stopper having a shape that prevents rotation of the nut, and
the second cover includes a first fitting portion to be fitted to the first rotation stopper of the flange.

5. The valve timing adjustment device according to claim 3, wherein the cylinder includes a second rotation stopper provided on an outer peripheral surface of the cylinder and having a shape that prevents rotation of the nut, and
the case includes a second fitting portion provided on an inner peripheral surface of the third through hole and fitted to the second rotation stopper of the cylinder.

6. The valve timing adjustment device according to claim 3, wherein the cylinder includes, on a side opposite to the end side where the flange is provided, a large inner diameter portion through which the bolt passes, the large inner diameter portion having an inner diameter larger than an inner diameter of a portion of the third through hole through which the bolt passes.
